(19) United States
(12) Patent Application Publication
(10) Pub. No.: US 2005/0116122 A1
(43) Pub. Date: Jun. 2, 2005

(54) Holder for elongated objects

(75) Inventor: Hideaki Nakanishi, Toyohashi-shi (JP)

Correspondence Address: MILES & STOCKBRIDGE PC, 1751 PINNACLE DRIVE, SUITE 500, MCLEAN, VA, 22102-3833, US

(73) Assignee: Newfrey LLC

(21) Appl. No.: 10/983,246

(22) Filed: Nov. 8, 2004

(30) Foreign Application Priority Data
Nov. 12, 2003 (JP) 2003-382037

(51) Int. Cl. F16L 3/22

(52) U.S. Cl. 248/68.1

(57) ABSTRACT

A holder of an elongated object has a main unit 10 and a cover unit 20 connected by a hinge 30. The main unit and the cover unit have walls 12 forming receptacles 13 for receiving the objects, and are formed of an electrically conductive hard resin. Inner surfaces of the curved walls and edges continuous therewith in at least one or the other of the main unit and the cover unit are covered by a soft member consisting of a soft resin. The soft member fills voids that are continuous with portions of the edges. The soft member in at least one or the other of the main unit and the cover unit is formed of an electrically conductive resin. The main unit, cover unit, and hinge are integrally formed as a primary molded member. The soft member is formed as a secondary molded member.

### CROSS-REFERENCE TO RELATED APPLICATION

This application claims the benefit of Japanese Patent Application No. 2003-382037 filed Nov. 12, 2003, incorporated herein by reference.

### BACKGROUND OF THE INVENTION

This invention relates to a holder for elongated objects, such as pipe, wire harnesses, or the like, and is more particularly concerned with a holder that holds objects securely and such that they do not become electrically charged.

In FIG. 12 is shown a section of a conventional holder 1 for holding pipe or the like for automobile fuel or brake fluid or the like. The conventional holder 1 comprises two curved pipe holding units 6 for admitting pipe 2 having a circular cross-section, and one pipe holding unit 6′ for admitting a pipe 3 that is narrower than the pipe 2. Above each of the pipe holding units 6 is provided a pair of elastic holding pieces 7. These elastic holding pieces 7 are made so that they temporarily bend when the pipe 2 is inserted, and then, after the pipe 2 has been inserted, return to the original position to hold the pipe 2. Above the pipe holding unit 6′ is provided one elastic holding piece 7′. The holder 1 also comprises a hole 8 through which passes a stud bolt 5, and pawls 9 for engaging the threads of the stud bolt 5, for securing the holder 1 to a stud bolt 5 erected on an automobile body panel 4.

With the conventional holder shown in FIG. 12, pipe or the like can be easily attached to an automobile body panel. However, because such a holder is generally an integral molding of plastic, it sometimes becomes electrically charged due to friction or the like with a fluid such as a fuel. When the holder becomes electrically charged, problems arise, such as sparks that are produced between it and the metal of the body panel or the like; the outer surface is damaged; coating layers peel away so that anti-corrosion properties deteriorate; and the flow of the fluid of the fuel or the like is impeded.

With the conventional holder, moreover, after the pipe has been attached, the pipe will sometimes shift in the axial direction due to operations such as installing and removing connectors in order to connect the pipe with other pipe, and the holder is sometimes deformed by such pipe shifting. With the holder shown in FIG. 12, in particular, pipe shifting occurs when a force of 10 to 30 N or so is applied in the axial direction. When the pipe is coated with a resin, the friction resistance increases, and shifting with the holder does not readily occur, but even in that case the holder can only withstand a force of up to 30 to 40 N or so.

Patent Literature 1 (Japanese Laid-Open Patent Application No. 2000-266240) discloses a pipeline attachment unit having a pipeline holding unit consisting of a plastic in which carbon black has been dispersed, and a bracket made of steel plate for enclosing and holding that pipeline holding unit. The pipeline attachment unit of Patent Literature 1 exhibits improved electrical conductivity. However, it is necessary to use two parts of differing material, namely the steel-plate bracket and the plastic pipeline holding unit, so the pipeline attachment unit becomes costly. In addition, the pipeline holding unit holds a pipeline which has been inserted into a channel-shaped receptacle, so there are shortcomings therewith in that the pipeline holding force is insufficient, and in that the pipe readily shifts when a force is applied thereto in the axial direction.

Patent Literature 2 (Japanese Laid-Open Patent Application No. H9-79432/1997) discloses a clip in which a shift-preventing layer consisting of an elastic resin material is provided on the inner surface of a concave unit for holding pipe. The shift-preventing layer passes around and into the two side edges of a concave engagement unit into which the object being secured is engaged, in substantially a U-shape, and is secured to the main unit of the holder. Therefore, the shift-preventing layer can be prevented from peeling away when a force is applied to the object being secured in the axial direction. The clamp described in Patent Literature 2 is such that the shift-preventing layer will not readily peel away, but, because the pipe is held by elastic deformable pieces for preventing the pipe from coming out (corresponding to the elastic holding pieces shown in FIG. 12), the pipe holding force is not sufficient, and the function of preventing shifting when a force is applied to the pipe in the axial direction is not sufficient either.

### BRIEF DESCRIPTIONS OF THE INVENTION

Accordingly, an object of the present invention is to provide a holder for securely holding elongated objects, such as pipe or the like so that they will not shift from the holder, and to provide a holder in which the pipe or the like will not become electrically charged.

A further object is to provide a holder which will hold pipe or the like securely, without shifting even when a strong force of 100 N or so is applied to the pipe in the axial direction.

Another object is to provide a holder comprising few parts and in which attachment is easy.

In one non-limiting embodiment of the invention, a holder for holding elongated objects such as pipe, has a main unit and a cover unit connected by a hinge. The main unit and the cover unit have curved walls which form pipe receptacles for admitting long, narrow objects, and are formed of an electrically conductive hard resin material. Although this description refers specifically to pipe, for simplicity of explanation, it will be apparent that the invention is not limited to holding pipe but is applicable to holding other elongated objects, such as wire harnesses, for example.

The inner wall surfaces of the curved walls in at least one of the main unit and the cover unit, and a portion of the edges in the width dimension (axial direction of the pipe) continuing-from the inner wall surfaces are covered with a soft member made of a soft resin material. Voids continuing from the portion of the edges in the width dimension are filled with the soft member, and the soft member is formed so as to be continuous from the inner wall surfaces via the edges in the width dimension to the voids.

In the holder, the portion that holds the pipe, in at least one or other of the main unit and the cover unit, is covered with the soft member, whereby the pipe can be held with sufficient holding force, and the pipe will not shift from the holder even if a force is applied thereto in the axial direction. If the portions holding the pipe in both the main unit and cover unit are covered with a soft member, the pipe can be held with even greater holding force. Also, because the pipe is gripped such that it is sandwiched between the main unit and cover unit, the pipe can be held with even greater holding force, but only a small force is required to insert the pipe into the pipe holding units, so that insertion is easy.

A soft member is formed continuously from the inner wall surfaces via the edges in the width dimension to the voids, so the soft member is firmly secured to the holder, and will not peel away from the holder even if the pipe is subjected to a strong force in the axial direction.

A soft member may be formed in one of or both of the main unit and the cover unit, and at least one or the other of the soft member formed in the main unit and the soft member formed in the cover unit is preferably formed of an electrically conductive resin. When one soft member is electrically conductive, the other may be formed of a non-conductive resin, but the pipe can still be prevented from becoming electrically charged.

More specifically, when soft members are formed in both the main unit and cover unit, the pipe will be conductive with the holder if at least one or other of the soft member formed in the main unit and the soft member formed in the cover unit is formed of an electrically conductive resin. When an electrically conductive soft member is formed only in either the main unit or the cover unit, the pipe will still be electrically conductive with the holder. Electrical conductivity between the pipe and an automobile body can be obtained through a bolt or the like which secures the holder, so electrical charging of the pipe can be prevented.

The main unit, the cover unit, and the hinge are preferably integrally formed as a primary molded member. The inner wall surface and edges in the width dimension of the curved walls in at least one or the other of the main unit and the cover unit are covered with a soft member, and the soft member or members filling the voids are preferably formed as a secondary molded member of a soft resin material. The molding of this secondary molded member, that is, the covering by the soft member(s) and the filling of the voids, can be done by two-color molding or by insert molding. Accordingly, the number of parts can be reduced, and the number of assembly steps can also be reduced.

It is preferable that the main unit and the cover unit be provided, both at one end near the hinge and at the other end remote from the hinge, with securing means for securing the main unit and the cover unit to one another.

In the main unit, attachment means for attaching the main unit to a support such as a car body is preferably provided.

In the holder of the present invention, the portions holding the pipe are covered by a soft member or members, so the pipe can be held with sufficient holding force, and the pipe will not shift from the holder even if a strong force is applied thereto in the axial direction. Also, because the pipe is gripped such that it is sandwiched between the main unit and cover unit, the pipe can be held with even greater holding force. Nevertheless, only a small force is required to insert the pipe into the pipe holding units, so that insertion is easy.

Since a soft member is formed continuously from the inner wall surfaces via the edges in the width dimension to the voids, the soft member is firmly secured, and will not peel away even if the pipe is subjected to a strong force in the axial direction.

### BRIEF DESCRIPTION OF THE DRAWINGS

The invention will be further described in conjunction with the accompanying drawings, which show a preferred (best mode) embodiment, and wherein:

FIG. 1 is a perspective view of a primary molded member of a holder, prior to molding a secondary molded member, according to a first embodiment of the present invention;

FIG. 2 is a view of the holder, after molding the secondary molded member, according to the first embodiment of the present invention;

FIG. 3 is a front elevation of the primary molded member shown in FIG. 1;

FIG. 4 is a section at line A-A in FIG. 3;

FIG. 5 is a section at line B-B in FIG. 3;

FIG. 6 is a section at line C-C in FIG. 3;

FIG. 7 is a front elevation of the holder shown in FIG. 2;

FIG. 8 is a section at line D-D in FIG. 7;

FIG. 9 is a section at line E-E in FIG. 7;

FIG. 10 is a section at line F-F in FIG. 7;

FIG. 11 is a section representing the condition wherein the holder shown in FIG. 2 is attached to a body panel; and

FIG. 12 is a section representing the condition wherein a conventional holder is attached to a body panel.

### DETAILED DESCRIPTION OF THE INVENTION

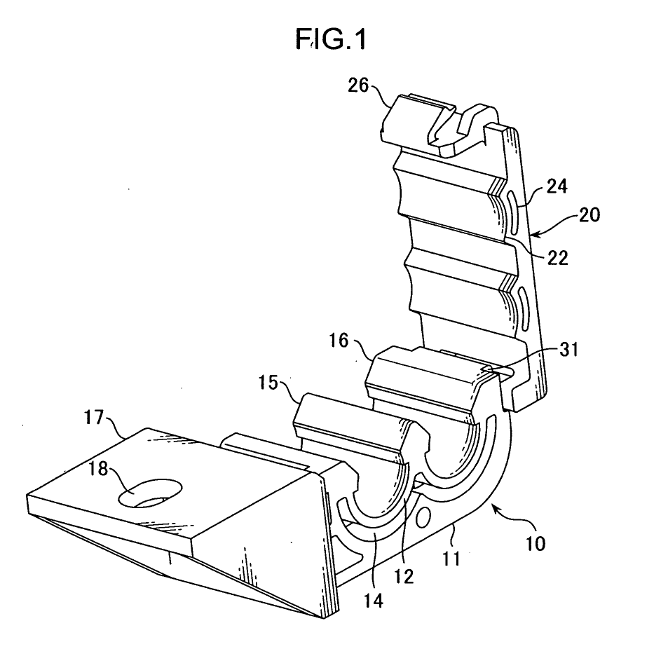

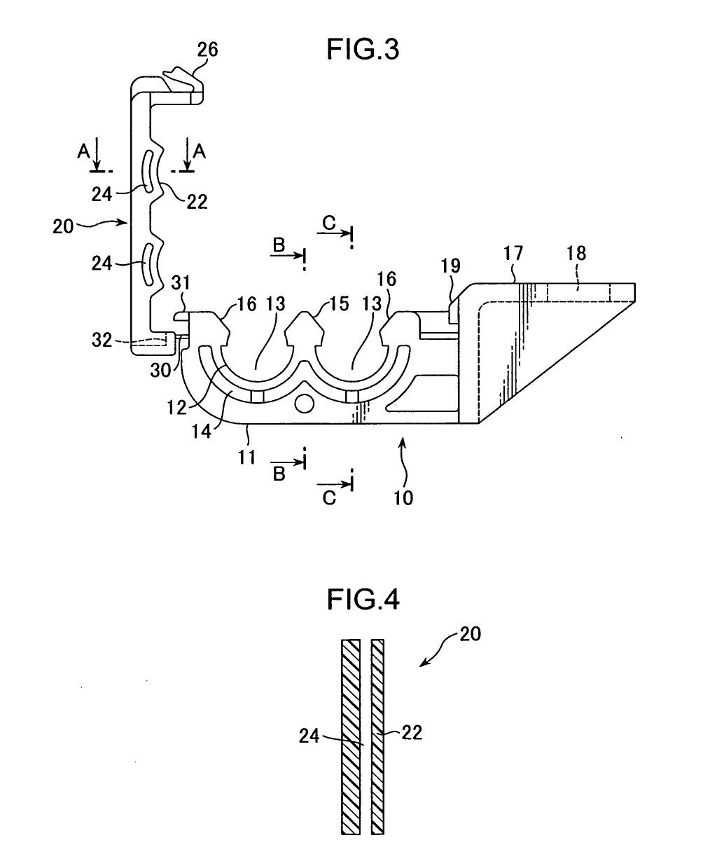

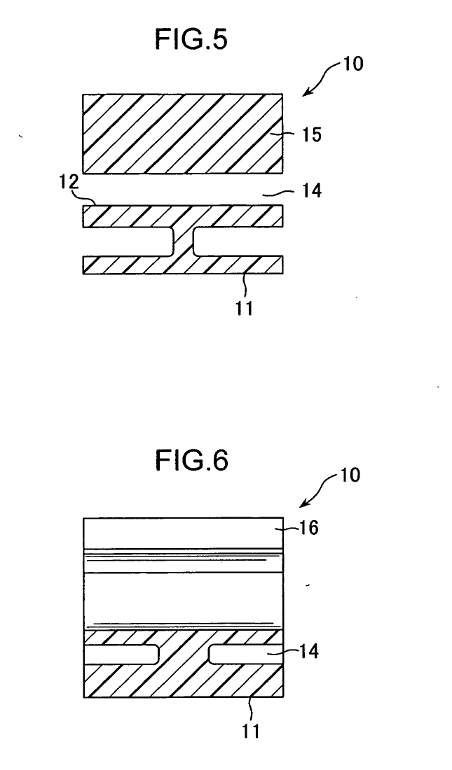

Referring to the drawings, in a preferred embodiment, a primary molded member has a main unit 10 and a cover unit 20 connected thereto for turning about an axis of a hinge 30 of thin material, as shown in FIGS. 1 and 3-6. The main unit 10, cover unit 20, and hinge 30 are preferably integrally molded of a hard resin material, as by injection molding. This hard resin material is an electrically conductive resin. The main unit 10 comprises a base 11 and two curved walls 12 for holding two pipes, above the base 11. The insides of the curved walls 12 are pipe receptacles 13. As shown in the front elevation in FIG. 3 and in the B-B and C-C sections in FIGS. 5 and 6, curved voids 14 are formed along the curved walls 12 between the base 11 and the curved walls 12. The configuration is such that a soft member (secondary molded member), described subsequently herein, can fill the voids 14.

In this embodiment, the voids 14 are of a shape that curves along the curved walls 12, but the shape of the voids 14 is not limited thereto. The shape of the voids 14 need only be such that a soft member can be filled around and in from the curved walls 12, a shape ensuring that the soft member will be firmly secured to the main unit.

Above and between the two curved walls 12, a pipe holding piece 15 is provided. The pipe holding piece 15 widens from the peak downward, with the width of the lower end of the pipe holding piece 15 being wider than the interval between the two curved walls 12. Above the curved walls 12, also, pipe holding pieces 16 are provided, on the sides of the curved walls 12 opposite the pipe holding piece 15. The sloping surfaces of the pipe holding pieces 16 are inclined so that, as they slope from higher to lower, they approach closer to the curved walls 12, so that the intervals between the pipe holding piece 15 and the pipe holding pieces 16 narrow toward the lower part, becoming shorter at the narrowest points than the distance between the opposing upper extremities of the curved walls 12. The configuration is such that, after pipe has been pushed into the pipe receptacles, the pipe is secured in the pipe receptacles 13 by the pipe holding piece 15 and the pipe holding pieces 16.

At one end of the main unit 10, adjacent to the hinge 30, a projection 31 is provided for engaging a catch 32 in the cover unit 20, for securing the cover unit 20 when the cover unit 20 is closed. At the other end, a cover locking wall 19 is provided for engaging a cover locking pawl 26 in the cover unit 20, described subsequently herein, when the cover unit 20 is closed.

Continuous with the base 11 of the main unit 10, an attaching bracket 17 is provided for securing the holder by a bolt or the like to an automobile body panel or the like. A hole 18 is formed in the attaching bracket 17 for passing a bolt or the like therethrough.

Next, the cover unit 20 of the primary molded member of the holder will be described. As shown in FIG. 3, two curved walls 22 are provided in the cover unit 20, at positions corresponding to the curved walls 12 in the main unit 10 when the cover unit 20 is closed, for holding down the pipe. As shown in FIG. 3 and in the A-A section in FIG. 4, voids 24 are formed so as to curve along the curved walls 22. These voids 24 are formed so that a soft member, described subsequently herein, can be inserted therein.

In this embodiment, two pipe holding units of the same size are provided, but the pipe holding units can be formed in various sizes and shapes so as to hold various elongated objects such as fuel lines or brake lines. The number, sizes, and shapes of the pipe holding units can be selected at will so as to match the pipe or the like to be held.

In this embodiment, moreover, the holder is a structure that can be secured to a body panel by a bolt and a nut, but the structure for securing to a body panel is not limited thereto, and can be a structure that secures the holder to a stud bolt erected on the body panel, or some other structure.

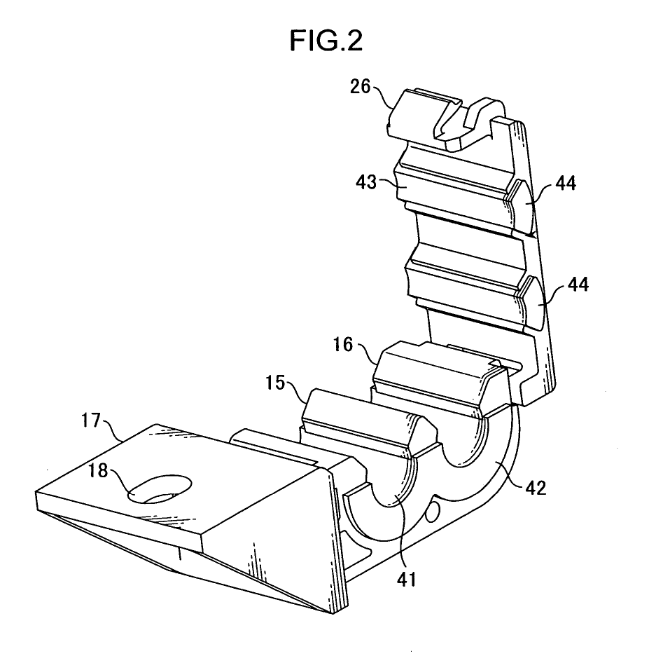

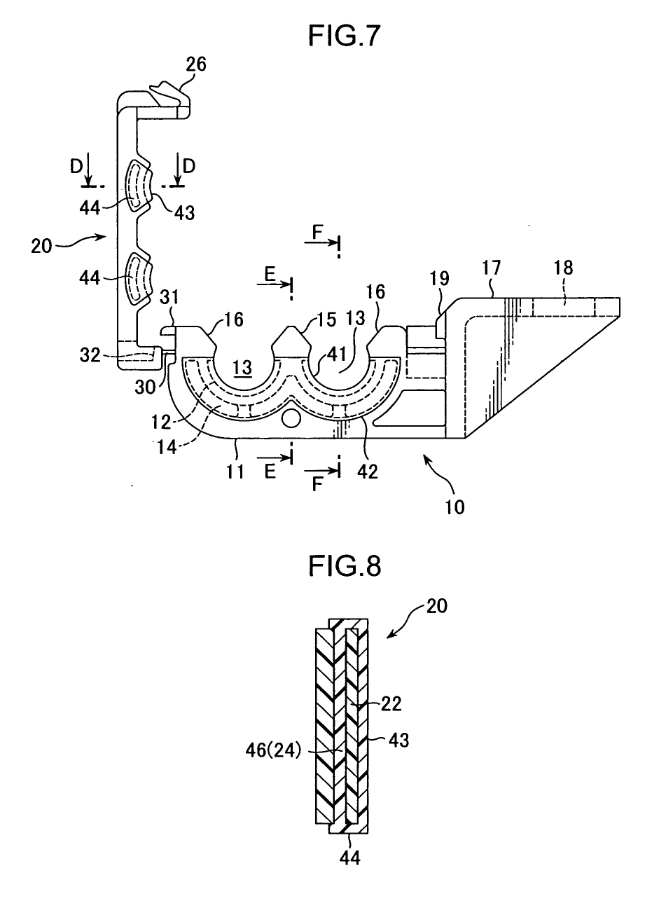

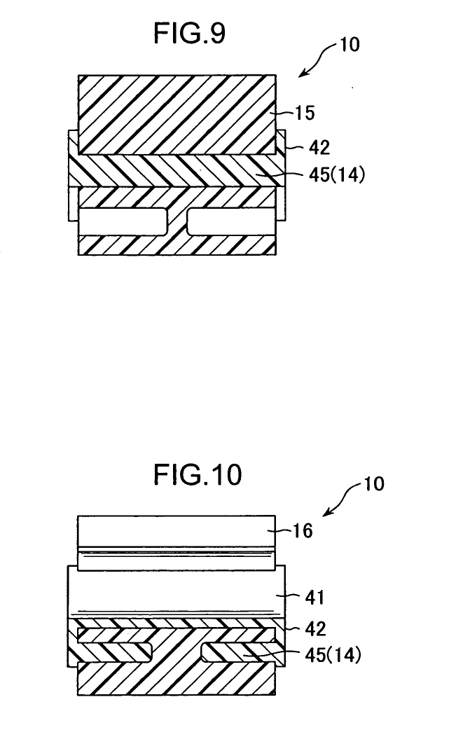

In the present invention, the pipe holding units in the main unit 10 of the primary molded member are covered with a soft member (secondary molded member) made of a soft resin material, thereby providing a holder of the present invention shown in FIG. 2. The soft member is shown in detail in FIGS. 7 to 10. The D-D, E-E, and F-F sections shown in FIGS. 8 to 10 correspond, respectively, to the A-A, B-B, and C-C sections shown in FIGS. 4 to 6. As shown in the front elevation in FIG. 7, and in the E-E and F-F sections in FIGS. 9 and 10, the soft member covers the inner wall surfaces of the curved walls 12 in the main unit 10, forming curved surfaces 41 for receiving pipe. The soft member also passes around the outside of the edges of the curved walls 12 in the width dimension (width dimension of the pipe) to form outer portions 42. The soft member also fills the voids 14, forming filled-in portions 45. The soft member is continuous from the curved surfaces 41 on the curved walls 12, via the outer portions 42, to the filled-in portions 45.

Also, as shown in the front elevation in FIG. 7 and in the D-D section in FIG. 8, a soft member covers the inner wall surfaces of the curved walls 22 in the cover unit 20, forming curved surfaces 43 for receiving pipe. The soft member also passes around the outside of the edges of the curved walls 22 in the width dimension (axial dimension of the pipe) to form outer portions 44. Also, the soft member fills the voids 24, forming filled-in portions 46 (FIG. 8). The soft member is continuous from the curved surfaces 43 on the curved walls 22, via the outer portions 44, to the filled-in portions 46.

The covering by a secondary molded member can be done by two-color molding or insert molding. For that reason, both the number of parts and the number of assembly steps can be reduced. Covering can be done, for example, using a die which encloses the inner surfaces of the curved walls 12 in the main unit 10 and the inner surfaces of the curved walls 22 in the cover unit 20. In a condition wherein the primary molded member is set in the die, inside of the die space is open for forming the outer portions 42 outside the main unit 10, and space is open for forming the outer portion 44 outside the cover unit 20.

A soft resin material is melted, and the molten soft resin material is solidified inside the die. As a result, the soft resin material will form the curved surfaces 41 and 43 so as to enclose both the entirety of the curved walls 12 and 22, and the outer portions 42 and 44 of the edges of the holder in the width dimension. The soft member also fills the voids 14 and 24, forming the filled-in portions 45 and 46. Thereby, a soft member (secondary molded member) is bonded strongly to the curved walls 12 and 22, and will not readily peel away even if the pipe is subjected to forces in the axial direction. For the soft member, a soft resin material is selected which will function to prevent the pipe being held from shifting in the axial direction. A typical material is, for example, a thermoplastic elastomer (TPE).

A soft member formed in both the main unit and in the cover unit can be an electrically conductive material. Alternatively, one or the other of a soft member formed in the main unit and a soft member formed in the cover unit can be an electrically conductive material, and the other a non-conductive material.

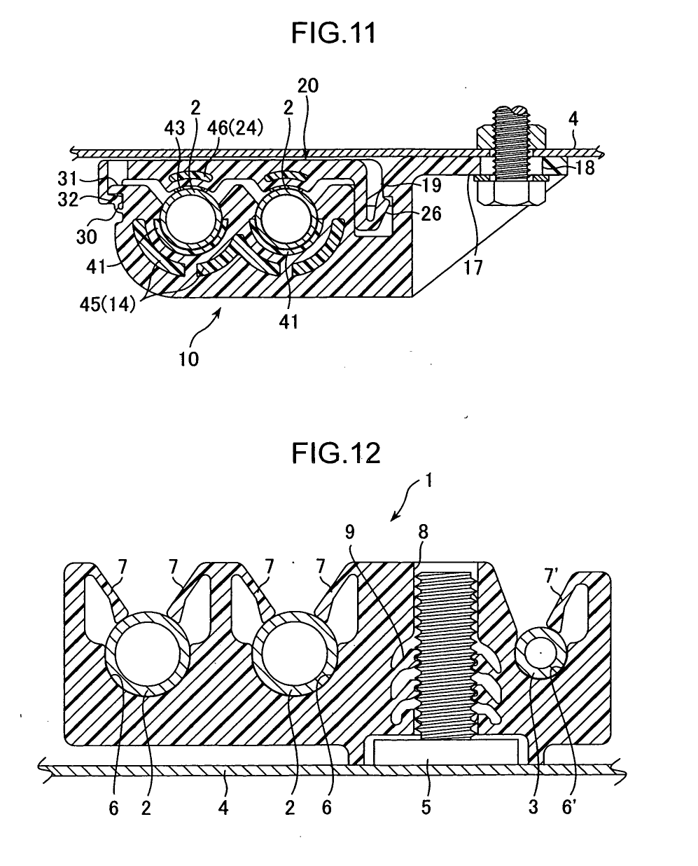

FIG. 11 is a section showing the condition wherein the holder is attached to a body panel. Procedures for attaching pipe 2 to a body panel 4 using a completed holder wherein the secondary molded member has been molded in the primary molded member will now be described. First, pipe is pushed into the pipe receptacles 13 covered by the soft member, pushing apart the pipe holding pieces 15 and 16 in the main unit 10, thereupon causing the pipe to be in contact with the outer surfaces of the curved surfaces 41 consisting of the soft member. Next, the cover unit 20 is turned about the axis of the hinge 30, and the cover unit 20 is closed so that it covers the main unit 10, and so that the curved surfaces 43 consisting of the soft member on the cover unit 20 are in contact with the outer surfaces of the pipe 2. When this is done, as shown in FIG. 11, the projection 31 adjacent to the hinge 30 in the main unit 10 catches the catch 32 in the cover unit 20, and the cover locking wall 19 in the main unit 10 and the cover locking pawl 26 in the cover unit 20 also engage, so that the pipe 2 is secured between the cover unit 20 and the main unit 10.

Securing means are configured at one end by the projection 31 of the main unit 10 and the catch 32 of the cover unit 20, and securing means are configured at the other end by the cover locking wall 19 of the main unit 10 and the cover locking pawl 26 of the cover unit 20. The cover locking wall 19 and the cover locking pawl 26 are configured so that, once they are engaged, they will not come loose unless intentionally moved so that the engagement of the cover locking pawl 26 is released.

As shown in FIG. 11, in order to attach the holder in this embodiment to a body panel, a bolt is passed through the hole 18 in the attaching bracket 17 of the holder and secured to a nut welded onto the body panel 4. The bolt and the nut configure attachment means. The method of attaching the holder to the automobile body panel 4 is not limited thereto. The holder can be secured to a stud bolt erected on the body panel, or provision may be made so that the holder is secured by anchor-shaped legs, for example.

The soft member functions to prevent the pipe 2 being held from shifting in the axial direction. More specifically, the soft member extends from the curved surfaces 41 on the curved walls 12 of the main unit 10, continues to the outer portions 42, and passes around and into the filled-in portions 45. Also, the soft member extends from the curved surfaces 43 on the curved walls 22 in the cover unit 20, continues to the outer portions 44, and passes around and into the filled-in portions 46. Thus, the soft member is strongly secured to the main unit and to the cover unit.

The pipe 2 is held, firmly sandwiched between the curved surfaces 41 and 43 consisting of the soft member, between the main unit 10 and the cover unit 20. Because the surfaces of the holder which are in contact with the pipe are the soft member, the friction force between the holder and the pipe is great, and the pipe will not shift, even when subjected to a strong force in the axial direction, that is, in the width direction of the curved walls. Moreover, even if a strong force is applied to the pipe in the axial direction, the soft member is bonded to the inner wall surfaces of the curved walls 12 and 22 and so will not peel away. Also, because the pipe is pressed down by the cover unit, even stronger resistance to shifting is exhibited.

The hard members in the main unit and cover unit are formed of an electrically conductive material. Also, at least one or other of the soft member formed in the main unit and the soft member formed in the cover unit is formed of an electrically conductive material. Therefore, electrical conductivity can be realized between the pipe and the holder, and any static electricity with which the pipe is charged can be conducted to the body panel.

In this embodiment, the soft member (secondary molded member) is formed in both the main unit 10 and the cover unit 20, so that the curved surfaces 41 and 42 consisting of the soft member make contact with the pipe. In a second embodiment of the present invention (not shown in the drawings), the soft member is formed in the main unit 10, but not in the cover unit 20, so that the pipe 2 is held by curved surfaces 41 consisting of the soft member of the main unit 10, and curved walls 22 consisting of the hard member of the cover unit 20. Even when the soft member is only formed in the main unit 10, the pipe 2 will be sandwiched between the main unit 10 and the cover unit 20, so even strong forces on the pipe in the axial direction can be adequately withstood. In the second embodiment, even if the soft member formed in the main unit 10 is non-conductive, the electrically conductive hard member of the cover unit 20 is in contact with the pipe 2, so electrical conductivity between the pipe 2 and the holder is realized. Accordingly, the soft member formed in the main unit 10 may be either electrically conductive or non-conductive.

In a third embodiment of the present invention (not shown in the drawings), the soft member is formed in the cover unit 20, but not in the main unit 10, so that the pipe 2 is held by the curved walls 12 consisting of the hard member of the main unit 10 and the curved surfaces 43 consisting of the soft member of the cover unit 20. Even when the soft member is only formed in the cover unit 20, the pipe 2 will be sandwiched between the main unit 10 and the cover unit 20, so even strong forces on the pipe in the axial direction can be adequately withstood. In the third embodiment, even if the soft member formed in the cover unit 20 is non-conductive, the electrically conductive hard member of the main unit 10 is in contact with the pipe 2, so electrical conductivity between the pipe 2 and the holder is realized. Accordingly, the soft member formed in the cover unit 20 may be either electrically conductive or non-conductive.

While preferred embodiments of the invention have been shown and described, changes can be made without departing from the principles and spirit of the invention, the scope of which is defined in the accompanying claims.

1. A holder for holding elongated objects, having a main unit and a cover unit connected by a hinge, wherein:
the main unit and the cover unit have curved walls forming receptacles for holding the objects, and are formed of a hard resin material that is electrically conductive;
inner surfaces of the curved walls in at least one of the main unit and the cover unit, and a portion of edges in a width dimension continuing from the inner wall surfaces, are covered with a soft member made of a soft resin material; voids continuing from the portion of the edges are filled with the soft member; and the soft member is formed so as to be continuous from the inner wall surfaces via the edges to the voids.

2. The holder described in claim 1, wherein the soft member is formed of an electrically conductive resin.

3. The holder described in claim 1, wherein soft members are formed in both the main unit and in the cover unit, and
at least one of the soft members formed in the main unit and in the cover unit is formed of an electrically conductive resin.

4. The holder described in claim 3, wherein an electrically conductive soft member is formed in only one of the main unit and the cover unit, and the other soft member is formed of a non-conductive resin.

5. The holder described in claim 1, wherein the main unit, the cover unit, and the hinge are formed integrally as a primary molded member, and
the soft member is molded as a secondary molded member of a soft resin material.

6. The holder described in claim 1, wherein the main unit and the cover unit are provided, both at one end near the hinge and at another end remote from the hinge, with securing means for securing the main unit and the cover unit to one another.

7. The holder described in claim 1, wherein the main unit is provided with attachment means for attaching the main unit to a support such as a car body.

8. A holder for an elongated object, having a main unit and a cover unit with cooperable elements for coupling the cover unit to the main unit, wherein:
the main unit and the cover unit have walls forming a receptacle for the object and formed of a plastic that is electrically conductive; and
inner wall surfaces of at least one of the main unit and the cover unit are covered with a softer, electrically conductive plastic.

9. The holder described in claim 8, wherein the main unit, the cover unit, and the cooperable elements are formed integrally as a primary molded member, and the softer plastic is formed as a secondary molded member.
